(19) United States
(12) Patent Application Publication
(10) Pub. No.: US 2014/0113612 A1
(43) Pub. Date: Apr. 24, 2014

(54) METHOD AND APPARATUS FOR SPECTRUM MANAGEMENT

(71) Applicant: Kodo Shu, Beijing (CN)

(72) Inventor: Kodo Shu, Beijing (CN)

(73) Assignee: NOKIA CORPORATION, Espoo (FI)

(21) Appl. No.: 14/126,778

(22) PCT Filed: Jun. 22, 2011
(86) PCT No.: PCT/CN2011/076125

§ 371 Date: Dec. 16, 2013

(51) Int. Cl. H04W 48/16; H04W 52/02; H04W 64/00

(52) U.S. Cl. CPC H04W 48/16; H04W 64/006; H04W 52/0206
USPC 455/418; 455/574

(57) ABSTRACT

In accordance with an example embodiment of the present invention, there is provided an apparatus comprising a receiver configured to receive information from a mobile device, the information comprising at least an indication of a location of the mobile device, at least one processing core configured to determine availability information concerning a 5 cell based at least in part on the information received from the mobile device, the availability information defining the cell to be available or not available, a transmitter configured to transmit to the mobile device advice concerning the cell determined to be available or not available, the transmitter being further configured to transmit to the cell determined to be available or not available an instruction, wherein the instruction is 10 configured to cause the determined cell to become active or inactive.

### TECHNICAL FIELD

The present application relates generally to managing radio spectrum and to mobile wireless communication.

### BACKGROUND

Mobile communication requires that an amount of information is transmitted successfully. As mobile services have become more complex and data-intensive, requirements on datarates, or the amounts of data transmitted per time interval, have increased. Transferring digitized and coded speech consumes a lower datarate than browsing the internet, and streaming a high-quality movie may consume an even larger datarate.

Various solutions to increasing datarates in cellular communication systems have been implemented. In time-division systems, the number of timeslots allocated to serving a user requiring a high datarate can be increased. In code division systems, the number of spreading codes allocated to serving a user requiring a high datarate can be increased. In various radio communication systems, the used modulation may be changed to one of higher order, such that the number of bits communicated per symbol increased, for example 16-QAM, or 16-quadrature amplitude modulation, offers a higher rate than binary phase-shift keying, BPSK, modulation.

One solution to increasing a datarate is to use more than one carrier simultaneously. In a time-division system, for example, after allocating all timeslots in one carrier to one user, the user may be provided with at least part of another carrier such that half of the user's data is transmitted via a first carrier and half via a second carrier, for example. Using more than one carrier simultaneously requires that a receiver, for example a mobile device, is capable of receiving more than one frequency simultaneously. Using more than one carrier simultaneously may be termed multicarrier communication.

### SUMMARY

Various aspects of examples of the invention are set out in the claims.

According to a first aspect of the present invention, there is provided an apparatus comprising a receiver configured to receive information from a mobile device, the information comprising at least an indication of a location of the mobile device, at least one processing core configured to determine availability information concerning a cell based at least in part on the information received from the mobile device, the availability information defining the cell to be available or not available, a transmitter configured to transmit to the mobile device advice concerning the cell determined to be available or not available, the transmitter being further configured to transmit to the cell determined to be available or not available an instruction, wherein the instruction is configured to cause the determined cell to become active or inactive.

According to a second aspect of the present invention, there is provided a method, comprising receiving information from a mobile device, the information comprising at least an indication of a location of the mobile device, determining availability information concerning a cell based at least in part on the information received from the mobile device, the availability information defining the cell to be available or not available, transmitting to the mobile device advice concerning the cell determined to be available or not available, and transmitting to the cell determined to be available or not available an instruction, wherein the instruction is configured to cause the determined cell to become active or inactive.

According to a third aspect of the present invention, there is provided an apparatus, comprising at least one processor, at least one memory including computer program code, the at least one memory and the computer program code configured to, with the at least one processor, cause the apparatus to perform at least the following: transmit information comprising at least an indication of a location of the apparatus, receive advice concerning a cell, and cause carrier aggregation between a first carrier from the apparatus to a cellular communication network and a second carrier established from the apparatus to the cell, wherein the second carrier is comprised in an unlicensed frequency band.

According to a fourth aspect of the present invention, there is provided a method, comprising transmitting information comprising at least an indication of a location of an apparatus, receiving advice concerning a cell, and causing carrier aggregation between a first carrier from the apparatus to a cellular communication network and a second carrier established from the apparatus to the cell, wherein the second carrier is comprised in an unlicensed frequency band.

Aspects of the present invention also comprise computer programs configured to cause methods in accordance with embodiments of the present invention to be performed, when said computer programs are run. The computer programs may be stored on computer-readable media, such as non-transitory storage media.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example system capable of supporting some embodiments of the invention.

FIG. 2 illustrates an example apparatus according to some embodiments of the invention.

FIG. 3 is a first flow diagram showing operations for a method according to some embodiments of the invention.

FIG. 4 is a second flow diagram showing operations for a method according to some embodiments of the invention.

### DETAILED DESCRIPTION OF THE DRAWINGS

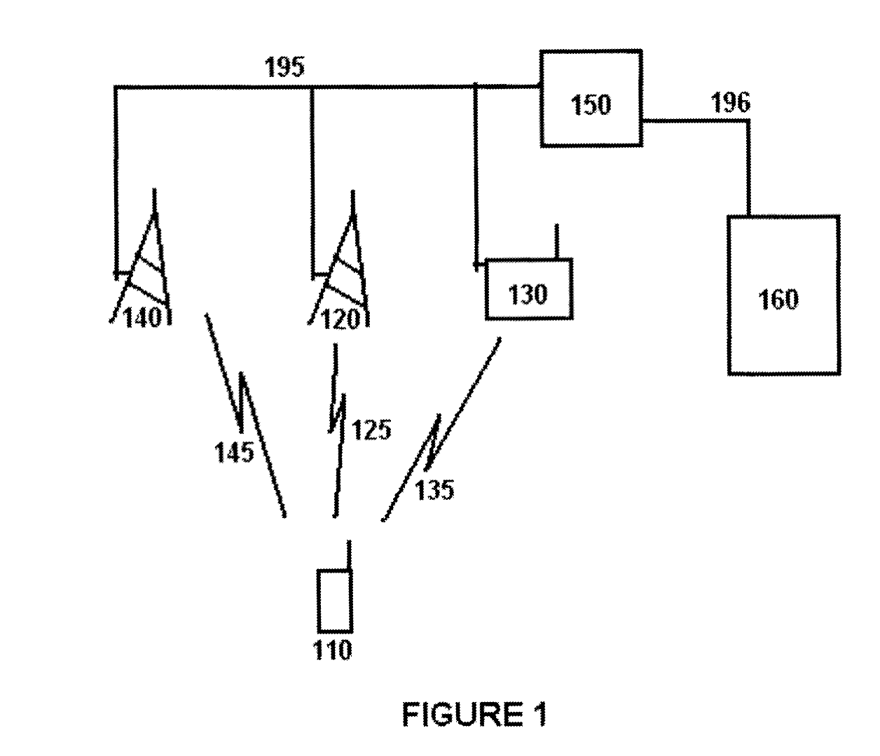

An example embodiment of the present invention and its potential advantages are understood by referring to FIGS. 1 through 4 of the drawings.

FIG. 1 illustrates an example system capable of supporting some embodiments of the invention. The system comprises mobile 110, which may be a cellular telephone, personal digital assistant, PDA, cellular or tablet computer or another kind of device, for example. Base stations 120 and 140 may be configured to operate according to at least one cellular standard, such as global system for mobile communication, GSM, wideband code division multiple access, WCDMA or long term evolution, LTE, for example. Access point 130 may be considered to control a cell of its own. Base stations 120 and 140 may be configured to communicate using a pre-defined band of licensed spectrum, which has been allocated by authorities for cellular communication. Access point 130 may operate according to wireless local area network, WLAN, or worldwide interoperability for microwave access, WiMAX, technologies, for example. Access point 130 may be configured to communicate wirelessly using an unlicensed spectrum band. An example of an unlicensed spectrum band is a spectrum band allocated to television broadcasts, which is not in use in the area where access point 130 is located. In some embodiments, access point 130 is a mobile device.

Mobile 110 may be capable of communicating with at least one cellular protocol used by base stations 120 and/or 140, as well as a frequency band used by access point 130. In FIG. 1 this is illustrated by wireless links 125, 135 and 145. Wireless link 125 interconnects mobile 110 and base station 120. Wireless link 125 may comprise a downlink for conveying information from base station 120 to mobile 110. Wireless link 125 may comprise an uplink for conveying information from mobile 110 to base station 120. Wireless link 125 may conform to a cellular communication standard, for example. Wireless link 125 may be based on GSM, WCDMA, LTE or another standard. Wireless link 125 may be based on orthogonal frequency division multiple access, OFDMA, code division multiple access, CDMA, time divisions multiple access, TDMA, or a combination of these, for example. Wireless link 145 may be substantially similar to wireless link 125.

Wireless link 135 may be based on orthogonal frequency division multiple access, OFDMA, code division multiple access, CDMA, time divisions multiple access, TDMA, or a combination of these, for example. Wireless link 135 may comprise a downlink for conveying information from access point 130 to mobile 110. Wireless link 135 may comprise an uplink for conveying information from mobile 110 to access point 130. Mobile 110 may be capable of using wireless link 135 independently of its use of wireless link 125 and/or wireless link 145. That is, mobile 110 may communicate via wireless link 125 without having other links, or via wireless link 125 and wireless link 135 simultaneously, or only via wireless link 135 at any given time.

Mobile 110 may issue a request, for example via wireless link 125 and base station 120, for a high datarate. For example, mobile 110 may determine that in order to support a large file transfer or video stream, a high datarate is needed. Alternatively, mobile 110 may invoke a large file transfer or video stream from a cellular network which comprises base stations 120 and 140, responsive to which the cellular network may determine that mobile 110 needs a high datarate to successfully obtain the required service. Responsive to becoming aware that mobile 110 needs a high datarate, the cellular network may determine whether a single carrier is capable of providing it. If the needed datarate is higher than the maximum capacity of a single carrier in the cellular system, more than one carrier is required to provide the datarate. The LTE system, for example, provides a mechanism to aggregate carriers to provide higher datarates, whereby mobile 110 may aggregate more than one physical carrier into one high-capacity logical channel. The aggregated carriers may be carriers of the same or different base stations, such as base stations 120 and 140, for example. It is possible that mobile 110 is allocated 100% of a first carrier and a part, for example 20%, of another carrier so as to reach the needed datarate, for example. Carriers may be subdivided according to the standard in use, for example into spreading codes and timeslots. Thus for example mobile 110 may be served via a logical link comprising at least parts of both wireless link 125 and wireless link 145.

Aggregating carriers from a cellular network consumes resources from the cellular network and also from the frequency band or bands allocated to the cellular network. If bandwidth could be aggregated to a logical channel from an unlicensed band to complement wireless link 125, for example, an increase in datarate could be obtained without burdening the licensed band where the cellular network operates.

Access point 130 may be configured to operate on an unlicensed band, for example locally, in other words the cell radius of the cell controlled by access point 130 may be smaller than that of cellular cells. While the movement of mobile 110 relative to cellular base stations is monitored and controlled by procedures of the cellular system, it may be difficult for mobile 110 to know whether it is within communication range of an access point such as access point 130 operating on an unlicensed band. According to some embodiments of the invention, there is provided a server 150, comprised for example in a cellular network which mobile 110 can use. The backbone network of the cellular network is schematically illustrated as network 195 in FIG. 1. The backbone network may comprise apparatuses not illustrated in FIG. 1, such as for example base station controllers, switches, serving nodes, subscriber registers, gateways and the like. Access point 130 is functionally connected to server 150. Access point 130 may be connected to the cellular network by a wire-line connection as illustrated in FIG. 1, or alternatively access point 130 may be arranged to communicate with server 150 at least in part via a wireless connection. Examples of such connections comprise microwave links and also cellular or WLAN connections. Wireless connectivity between server 150 and access point 130 may be useful in embodiments where access point 130 is a mobile device.

Server 150 may be configured to store information of access points such as access point 130. Mobile 110 may be configured to report, for example via wireless link 125, its location to server 150. Mobile 110 may obtain its location via satellite positioning using GPS, GALILEO and/or GLONASS, or by triangulating from base stations such as base stations 120 and 140, for example. Responsive to receiving a location of a mobile, server 150 may be configured to responsively indicate, via the cellular network, to the mobile whether there are usable access points in close enough vicinity that the mobile might take advantage of them. Upon receiving the advice from server 150 mobile 110 may be capable of participating in communicating via at least two carriers, one via the cellular network via wireless link 125, for example, and another one via access point 130 via wireless link 135, for example. The at least two carriers may be comprised in a carrier aggregation to provide a single logical link to furnish mobile 110 with high-datarate communication.

In order to provide the single logical link to mobile 110, the cellular network may coordinate data transfer between base stations 120, 140 and access point 130. For example, where carrier aggregation is used to provide a video stream to mobile 110, a node comprised in the cellular network may cause the video stream to be partitioned so that a first part is transmitted via a carrier on wireless link 125 and a second part via a carrier on wireless link 135. Mobile 110 may be configured to receive information on the partitioning or otherwise determine how to assemble the entire stream from the first and second parts. In another example, mobile 110 may transmit a video stream originating from a camera comprised in mobile 110. Mobile 110 may transmit the video stream using a carrier aggregation between a carrier on wireless link 145 and a carrier on wireless link 135, for example.

Server 150 may receive information on access points 130 by receiving the information directly from access points 130. Access points 130 may be configured to report their operational parameters to server 150. Access points 130 may be configured to report their parameters to server 150 periodically or responsive to detecting a change in their operational parameters. For example, where an access point 130 detects or is informed of a change in its location, it may report the updated location to server 150. Similarly access point 130 may be configured to report a change in its cell size, maximum allowed transmit power, datarate or other parameters. Server 150 may alternatively or additionally receive information on access points 130 from a spectrum database 160. Spectrum database 160 may comprise information on television spectrum allocations or governmental spectrum allocations, for example. When spectrum allocated to digital or analog television transmissions, for example, is not in use in a geographically defined area, spectrum database 160 may inform server 150 of the area and the spectrum band not in use. Server 150 may use this information to compile a data structure comprising information on geographical locations and spectrum bands not in use, which may comprise information as to when the spectrum bands are not in use. For example, it may be possible to use television or governmental spectrum resources at night time, when spectrum database 160 has advised server 150 that the spectrum concerned is unused during nights.

In the United States, spectrum allocation authorities have issued rulings that allow devices that satisfy regulatory requirements to be able to access television bands which are unused at a specific place at a specific time. This part of television spectrum is called TV white space, or TVWS, and devices using it are called white space devices, or WSDs. One example of a spectrum database 160 is a database run by such spectrum allocation authorities. Some embodiments of the present invention allow to dynamically and opportunistically integrate spectrum resources such as TVWS into a carrier aggregation framework of a cellular communications network.

An apparatus, such as server 150, an integrated chip comprised in server 150 or another apparatus performing a similar function, may be configured to receive information from mobile 110, which information comprises at least an indication of a location of mobile 110. Server 150 may receive the information via wireless link 125 or 145 and network 195, for example. Server 150 may receive the information as a dedicated packet-based message or in connection with another message, for example a message associated with a location update. Server 150, or more exactly a processing device comprised therein, may be configured to compare the indication of the location of mobile 110 to information in a data structure stored in a memory comprised in server 150 to determine whether mobile 110 is within communication range of an access point 130, in other words whether mobile 110 is within a cell of an access point 130. Responsive to determining that mobile 110 is within range of an access point 130, server 150 may be configured to transmit to mobile 110 advice concerning access point 130, for example via a similar route as was used to receive the message from mobile 110. Server 150 may also be configured, responsive to determining that mobile 110 is within range of an access point 130, to transmit to the access point 130 of the determined cell an instruction to cause the access point to become activated. The advice to mobile 110 may be transmitted first and the instruction to the access point 130 after, or alternatively the other way around. Responsive to determining based on the received information that mobile 110 is no longer within range of an access point 130, server 150 may be configured to transmit a deactivate instruction to access point 130. Receiving and transmitting may occur at at least one external connector of server 150, or alternatively at at least one pin connecting at least one integrated chip to a circuit board within server 150.

The information from mobile 110 may comprise indications of a moving direction and velocity of mobile 110. Mobile 110 may determine these by determining its position twice with a known time separating the position instances, and then calculating the difference between the determined positions to determine direction and velocity. Server 150 may use this information to predictively determine a future time instant, when mobile 110 is likely to be within a cell of an access point 130.

The advice concerning access point 130 may comprise information on access point 130, such as at least one indication of frequency used by access point 130 and an indication of measurement cycles indicating how often mobile 110 should scan for access point 130. In some embodiments the information on access point 130 comprises an indication of when access point 130 will transmit a beacon signal, so mobile 110 can be prepared to measure it at the correct time. The time can be expressed as an absolute time or as a time defined by the cellular access system, for example. The advice may also comprise an identity of access point 130, for example a global cell identity, physical cell identity, a service set identifier, SSID, or another kind of identifier facilitating discovery of access point 130 by mobile 110.

In some embodiments the information on access point 130 comprises an indication of when mobile 110 is advised to contact access point 130. This time may be expressed as an absolute time or as a time defined by the cellular access system, for example.

In some embodiments, the instruction to cause access point 130 to become active may comprise or be transmitted with a time indication indicating a point in time when access point 130 is instructed to become active. Server 150 may determine this time from the location, direction and velocity information received from mobile 110 in connection with information concerning the location of access point 130 and the size of the cell of access point 130, for example. Where server 150 instructs mobile 110 to listen for a beacon from access point 130 at a specified time, server 150 may also instruct access point 130 to provide the beacon at the specified time. The specified time may be selected by server 150 to substantially correspond to a time when mobile 110 is predicted to enter the cell of access point 130, for example. When access point 130 isn't in use it may be in a sleep mode to conserve energy. In the sleep mode it may be capable of receiving information from server 150, but it may keep wireless interface 135 switched off, for example, to conserve energy. An instruction from server 150 to deactivate an access point 130, or place it in a sleep mode, may also comprise a predictively determined time indication indicating when the access point is to become inactive or enter a sleep mode. The determined time instance may substantially correspond to a time when mobile 110 is expected to leave communication range of access point 130, based on the motion direction and velocity information.

In some embodiments, the information received in server 150 from mobile 110 comprises at least one indication of a capability of the mobile device. Server 150 may be configured to use the at least one capability indication to determine a suitable access point 130 for communication with mobile 110. Server 150 may compare the at least one capability indication to indications of capability of access points 130 in the vicinity of mobile 110. In some embodiments, server 150 may receive capability indications concerning mobile 110 from a subscriber information repository comprised in the cellular network, such as a home subscriber server, HSS. Server 150 may be configured to query a subscriber information repository for capability indications concerning mobile 110 responsive to receiving location information of mobile 110.

In some embodiments, the at least one indication of a capability of the mobile device comprises an indication of a capability to communicate on a given frequency. The frequency may be defined as a frequency band or in terms of the cellular network, for example. A frequency band may be defined by indicating the lower-frequency boundary of the band and the band width, or alternatively by indicating both boundaries of the frequency band. The at least one indication of capability may also comprise an indication that mobile 110 is capable, or alternatively not capable, of carrier aggregation. The at least one indication of capability may also define what kind of carrier aggregations mobile 110 is capable of participating in. For example, the indication may define that mobile 110 is capable of aggregating two kinds of unlicensed-band carriers to a cellular carrier, allowing server 150 to select a more suitable access point 130 for mobile 110. The choice may be based on battery consumption characteristics, datarate or cell size information, for example. The at least one indication of capability may also define how much battery mobile 110 has left.

Server 150 may be configured to receive information on characteristics and operating parameters of access points 130. Operating parameters may comprise a maximum power value access point 130 is allowed to use, and/or a receiver sensitivity of access point 130. Server 150 may use either one, or both, to calculate an estimate of cell size, or coverage area, for access point 130. Server 150 may receive information concerning access points 130 directly from the access points, or alternatively from a spectrum database 160, for example, as discussed above.

In accordance with some embodiments of the invention, mobile 110 may be configured to transmit the aforementioned information comprising at least an indication of a location of mobile 110 to server 150. Mobile 110 may be configured to receive the aforementioned advice from server 150, and mobile 110 may be configured to act on the advice to establish a carrier aggregation between a carrier on a cellular wireless link and a carrier on a non-cellular wireless link.

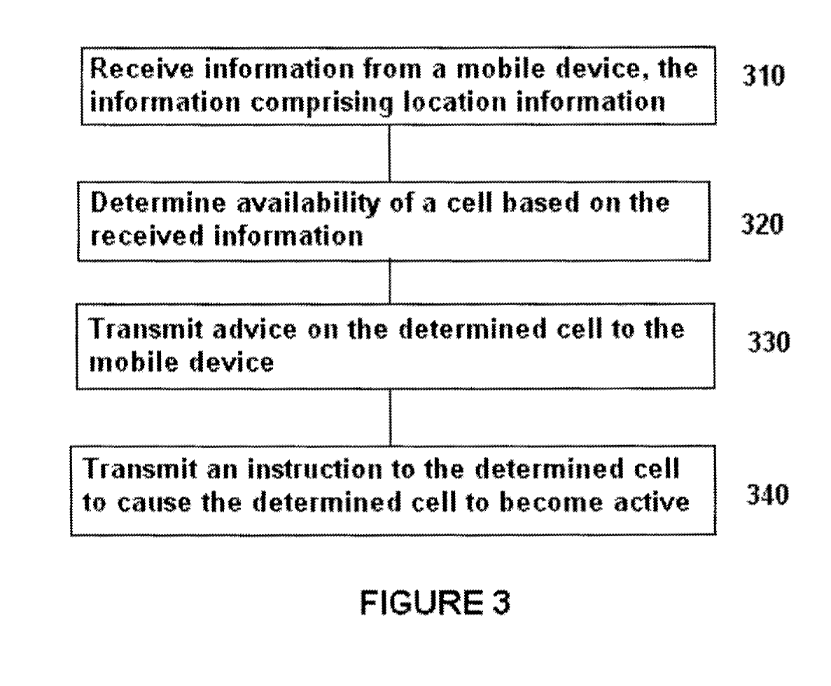

FIG. 3 is a flow diagram showing operations for a method according to some embodiments of the invention. In phase 310 an apparatus such as server 150 receives information from a mobile device, the information comprising at least location information. The information may be received partly via a wireless interface, for example a cellular wireless interface. In case server 150 receives the information directly from the mobile device, server 150 is comprised in a base station such as base station 120 or 140. A server 150 comprised in a base station may store information on access points 130 that lie within the cell of the base station. Such a server may be implemented as software running in the base station, for example.

In phase 320 server 150 may be configured to determine whether an access point 130 is reachable, or will soon be reachable, by mobile 110. The determination is performed at least in part based on the received location information. The contents of the location information have been discussed above.

In phase 330, server 150 may be configured to transmit to mobile 110 advice concerning at least one access point 130 that is reachable, or may soon become reachable. The contents of the transmitted advice have been discussed above. Transmitting the advice may occur over the same interface or interfaces as the receiving of the information from mobile 110.

In phase 340, server 150 may be configured to transmit an instruction to a determined access point 130, the instruction instructing access point 130 to transition to an active mode where it is capable of communicating with mobile 110. Phase 330 may precede phase 340, or alternatively phase 340 may precede phase 330.

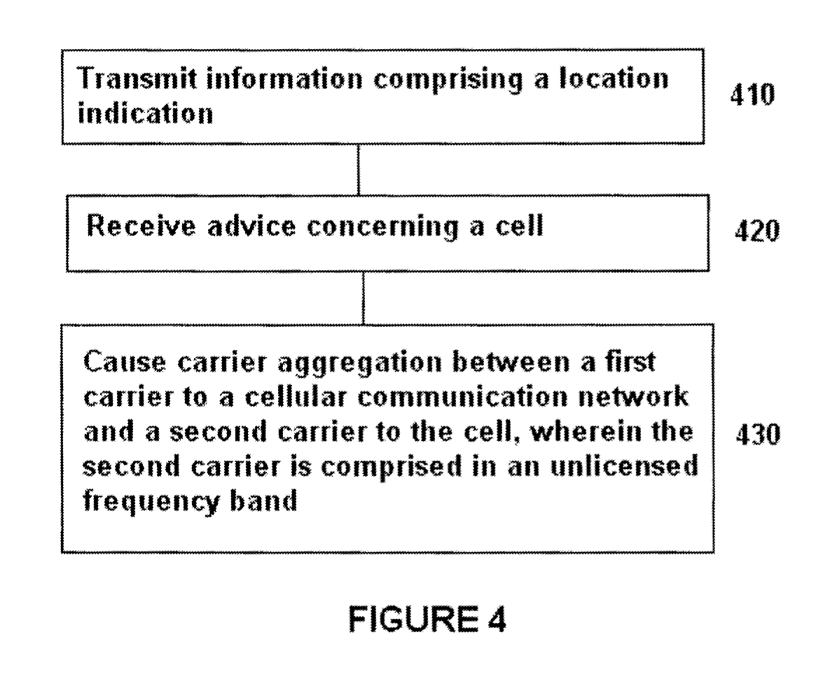

FIG. 4 is a second flow diagram showing operations for a method according to some embodiments of the invention. The method may take place in mobile 110, for example. In phase 410 mobile 110 may be configured to transmit information toward server 150, the information comprising at least a location indication of a location of mobile 110. Mobile 110 may obtain an estimate of its location by various methods, as discussed above. Mobile 110 may also indicate, in the same message as the location information or in another message, that it requires a service. The delivery of the required service may require a certain datarate to be available. Mobile 110 may also inform server 150 of capabilities of mobile 110, in the same message as the location information or alternatively in another message.

In phase 420 mobile 110 may be configured to receive directly or indirectly from server 150 advice concerning a cell, for example a cell associated with an access point 130. Mobile 110 may in some embodiments associate the received advice with the indicated request for a service. As discussed above, the advice may comprise information on the cell, timing information and other indications.

In phase 430, mobile 110 may be configured to act on the advice received in phase 420 by associating itself with the cell referred to in the advice. After associating itself with the cell, mobile 110 may participate in establishing communication over a wireless interface 135 between itself and the advised cell, and participate in establishing a carrier on the wireless interface. Mobile 110 may also participate in causing a carrier aggregation to occur involving at least one cellular carrier and the carrier established between mobile 110 and the advised cell. After the carrier aggregation has been successfully established, mobile 110 may be furnished with the requested service using a single logical channel provided by the carrier aggregation. The requested service may be a high-datarate service, for example.

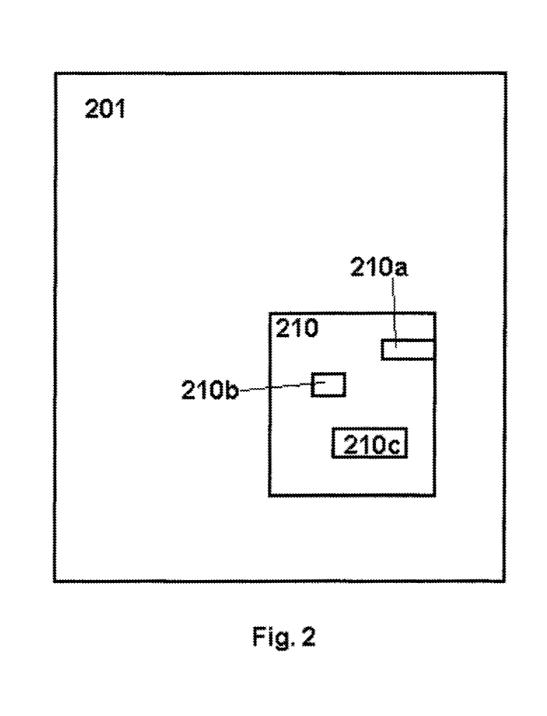

FIG. 2 illustrates an example apparatus 201 capable of supporting embodiments of the present invention. The apparatus may correspond to mobile 110, or base station 120, for example. The apparatus is a physically tangible object, for example a mobile telephone, personal digital assistant, data dongle, tablet or laptop computer or a similar device. The apparatus may comprise at least one control apparatus 210, for example a digital signal processor, DSP, processor, field-programmable gate array, FPGA, application-specific integrated circuit, ASIC, chipset or controller. The apparatus may further comprise a transmitter and/or a receiver 210a configured to enable the apparatus 201 to connect to other apparatuses. A combination of transmitter and receiver may be called a transceiver. The apparatus may comprise memory 210b configured to store information, for example advice concerning a cell. The memory may be solid-state memory, dynamic random access memory, DRAM, magnetic, holographic or other kind of memory. The apparatus may comprise logic circuitry and/or at least one processing core 210c configured to access the memory 210b and control the transmitter and/or a receiver 210a. The logic circuitry and/or at least one processing core 210c may be implemented as software, hardware or a combination of software and hardware. The logic circuitry and/or at least one processing core may comprise at least one processing core. The logic circuitry and/or at least one processing core 210c may execute program code stored in memory 210b to control the functioning of the apparatus 201 and cause it to perform functions related to embodiments of the invention. The logic circuitry and/or at least one processing core 210c may be configured to initiate functions in the apparatus 201, for example the sending of data units via the transmitter and/or a receiver 210a. The logic circuitry and/or at least one processing core 210c may be control circuitry. The transmitter and/or a receiver 210a, memory 210b and/or logic circuitry and/or at least one processing core 210c may comprise hardware and/or software elements comprised in the control apparatus 210. Memory 210b may be comprised in the control apparatus 210, be external to it or be both external and internal to the control apparatus 210 such that the memory is split to an external part and an internal part. If the apparatus 201 does not comprise a control apparatus 210 the transmitter and/or a receiver 210a, memory 210b and logic circuitry and/or at least one processing core 210c may be comprised in the apparatus as hardware elements such as integrated circuits or other electronic components. The same applies if the apparatus 201 does comprise a control apparatus 210 but some, or all, of the transmitter and/or a receiver 210a, memory 210b and logic circuitry 210c are not comprised in the control apparatus 210. In embodiments where apparatus 201 is a mobile user equipment, apparatus 201 may comprise at least one antenna

Without in any way limiting the scope, interpretation, or application of the claims appearing below, a technical effect of one or more of the example embodiments disclosed herein is enabling opportunistic use of spectrum resources. Another technical effect of one or more of the example embodiments disclosed herein is that access points are switched on only when needed, which serves to conserve energy in connection with opportunistic use of spectrum.

Embodiments of the present invention may be implemented in software, hardware, application logic or a combination of software, hardware and application logic. The software, application logic and/or hardware may reside on memory 210b, the control apparatus 210 or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-28. (canceled)

29. An apparatus, comprising:
a receiver configured to receive information from a mobile device, the information comprising at least an indication of a location of the mobile device;
at least one processing core configured to determine availability information concerning a cell based at least in part on the information received from the mobile device, the availability information defining the cell to be available or not available;
a transmitter configured to transmit to the mobile device advice concerning the cell determined to be available or not available; and
the transmitter being further configured to transmit to the cell determined to be available or not available an instruction, wherein the instruction is configured to cause the determined cell to become active or inactive.

30. An apparatus according to claim 29, wherein the information received from the mobile device comprises an indication of a moving direction and a velocity of the mobile device.

31. An apparatus according to claim 29, wherein the advice transmitted to the mobile device comprises at least one of an indication of a frequency to be used in communication with the determined cell and an indication of measurement cycles indicating a cycle how often the mobile device is advised to measure the determined cell.

32. An apparatus according to claim 31, wherein the advice transmitted to the mobile device comprises a time indication indicating a point in time when the mobile device is advised to contact the determined cell.

33. An apparatus according to claim 29, wherein the instruction transmitted to the determined cell comprises a time indication indicating a point in time when the cell is to become active or not active.

34. An apparatus according to claim 29, wherein the information received from the mobile device comprises at least one indication of a capability of the mobile device, and the processing core is configured to determine the availability information in dependence of the indication of a capability of the mobile device.

35. An apparatus according to claim 34, wherein the at least one indication of a capability comprises at least one of an indication of capability to communicate on a given frequency and an indication of capability to communicate simultaneously on a set of given frequencies.

36. An apparatus according to claim 29, wherein the apparatus is configured to receive information concerning cells and operating parameters of cells.

37. An apparatus according to claim 36, wherein the operating parameters comprise at least one maximum power value, and the apparatus is configured to derive a coverage area of at least one cell in dependence of the at least one maximum power value.

38. An apparatus according to claim 37, wherein the information concerning cells and operating parameters of cells are received from the cells concerned.

39. An apparatus according to claim 29, wherein the apparatus is configured to be operated within a cellular communications network.

40. A method, comprising:
receiving information from a mobile device, the information comprising at least an indication of a location of the mobile device;
determining availability information concerning a cell based at least in part on the information received from the mobile device, the availability information defining the cell to be available or not available;
transmitting to the mobile device advice concerning the cell determined to be available or not available; and
transmitting to the cell determined to be available or not available an instruction, wherein the instruction is configured to cause the determined cell to become active or inactive.

41. A method according to claim 40, wherein the information received from the mobile device comprises an indication of a moving direction and a velocity of the mobile device.

42. A method according to claim 40, wherein the advice transmitted to the mobile device comprises at least one of an indication of a frequency to be used in communication with the determined cell and an indication of measurement cycles indicating a cycle how often the mobile device is advised to measure the determined cell.

43. A method according to claim 42, wherein the advice transmitted to the mobile device comprises a time indication indicating a point in time when the mobile device is advised to contact the determined cell.

44. A method according to claim 40, wherein the instruction transmitted to the determined cell comprises a time indication indicating a point in time when the cell is to become active.

45. An apparatus, comprising:
at least one processor; and
at least one memory including computer program code
the at least one memory and the computer program code configured to, with the at least one processor, cause the apparatus to perform at least the following:
transmit information comprising at least an indication of a location of the apparatus;
receive advice concerning a cell; and
cause carrier aggregation between a first carrier from the apparatus to a cellular communication network and a second carrier established from the apparatus to the cell, wherein the second carrier is comprised in an unlicensed frequency band.

46. An apparatus according to claim 45, wherein the transmitted information comprises an indication of a moving direction and a velocity of the apparatus.

47. An apparatus according to claim 45, wherein the received advice comprises at least one of an indication of a frequency to be used in communication with the determined cell and an indication of measurement cycles indicating a cycle how often the apparatus is advised to measure the determined cell.

48. An apparatus according to claim 47, wherein the advice comprises a time indication indicating a point in time when the apparatus is advised to contact the cell.

49. A computer program product comprising a non-transitory computer-readable medium bearing computer program code embodied therein for use with a computer, the computer program code comprising:
code for transmitting information comprising at least an indication of a location of an apparatus;
code for receiving advice concerning a cell; and
code for causing carrier aggregation between a first carrier from the apparatus to a cellular communication network and a second carrier established from the apparatus to the cell, wherein the second carrier is comprised in an unlicensed frequency band.
